(19) United States
(12) Patent Application Publication
(10) Pub. No.: US 2025/0227500 A1
(43) Pub. Date: Jul. 10, 2025

(54) TIMING ADVANCE ACQUISITION FOR INTER CU MOBILITY

(71) Applicant: Samsung Electronics Co., Ltd., Suwon-si (KR)

(72) Inventor: Anil Agiwal, Allen, TX (US)

(21) Appl. No.: 19/004,099

(22) Filed: Dec. 27, 2024

Related U.S. Application Data
(60) Provisional application No. 63/618,159, filed on Jan. 5, 2024.
(60) Provisional application No. 63/571,908, filed on Mar. 29, 2024.

(51) Int. Cl. H04W 24/02; H04W 56/00

(52) U.S. Cl. CPC H04W 24/02; H04W 56/0015; H04W 56/0045

(57) ABSTRACT

A gNodeB (gNB)-central unit (CU) includes a processor, and a transceiver operatively coupled to the processor. The transceiver is configured to receive, from a source gNB-CU, a first request for an early uplink synchronization configuration of a target candidate cell, and transmit, to the source gNB-CU, the early uplink synchronization configuration of the target candidate cell.

### CROSS-REFERENCE TO RELATED APPLICATION(S) AND CLAIM OF PRIORITY

This application claims priority under 35 U.S.C. § 119 (e) to U.S. Provisional Patent Application No. 63/618,159 filed on Jan. 5, 2024, and U.S. Provisional Patent Application No. 63/571,908 filed on Mar. 29, 2024. The above-identified provisional patent applications are hereby incorporated by reference in their entirety.

### TECHNICAL FIELD

This disclosure relates generally to field. More specifically, this disclosure relates to timing advance (TA) acquisition for inter central unit (CU) mobility.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for TA acquisition for inter CU mobility.

In one embodiment, a gNodeB (gNB)-central unit (CU) is provided. The gNB-CU includes a processor, and a transceiver operatively coupled to the processor. The transceiver is configured to receive, from a source gNB-CU, a first request for an early uplink synchronization configuration of a target candidate cell, and transmit, to the source gNB-CU, the early uplink synchronization configuration of the target candidate cell.

In another embodiment, a user equipment (UE) is provided. The includes a transceiver configured to receive, from a serving cell, an early uplink (UL) synchronization configuration of a lower layer triggered mobility (LTM) candidate cell, and receive, from the serving cell, a physical downlink control channel (PDCCH) order for early timing advance (TA) acquisition of the LTM candidate cell, the PDCCH order initiating a random access (RA) procedure. The transceiver is also configured to transmit an RA preamble based on the early UL synchronization configuration to the LTM candidate cell. The UE also includes a processor operatively coupled to the transceiver. The processor is configured to, after transmission of the RA preamble, monitor a RA response (RAR) window for receipt of a RAR from the LTM candidate cell, and prioritize transmission and reception from the LTM candidate cell over transmission and reception from the serving cell.

In yet another embodiment, a method of operating a gNB-CU is provided. The method includes receiving, from a source gNB-CU, a first request for an early uplink synchronization configuration of a target candidate cell. The method also includes transmitting, to the source gNB-CU, the early uplink synchronization configuration of the target candidate cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4A illustrates an example NG-RAN overall architecture according to embodiments of the present disclosure;

FIG. 4B illustrates an example architecture for gNB-CU-CP and gNB-CU-UP separation according to embodiments of the present disclosure;

FIG. 5 illustrates example signaling procedures for inter-gNB handover according to embodiments of the present disclosure;

FIG. 6 illustrates an example procedure for early TA acquisition according to embodiments of the present disclosure;

FIG. 7 illustrates another example procedure for early TA acquisition according to embodiments of the present disclosure;

FIGS. 8A-8C illustrate another example procedure for early TA acquisition according to embodiments of the present disclosure;

FIG. 9 illustrates an example method for TA acquisition for inter CU mobility according to embodiments of the present disclosure; and

FIG. 10 illustrates another example method for TA acquisition for inter CU mobility according to embodiments of the present disclosure.

### DETAILED DESCRIPTION

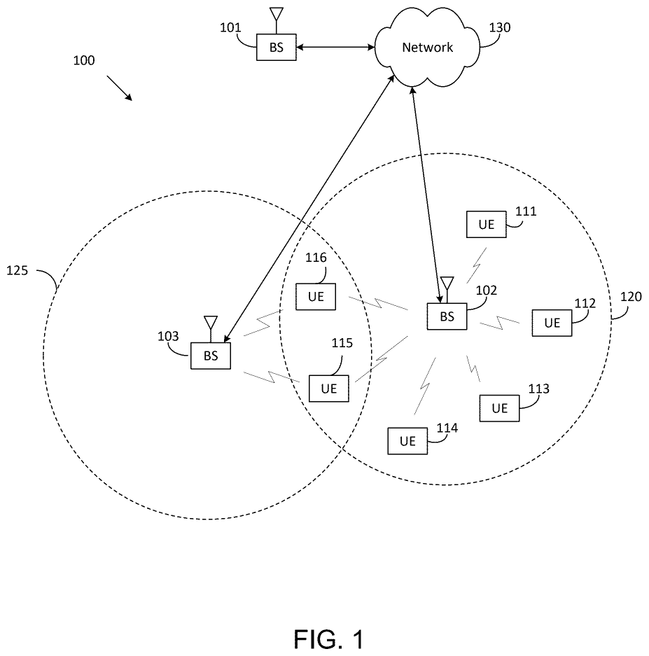

FIGS. 1 through 10, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for TA acquisition for inter CU mobility. In certain embodiments, one or more of the gNBs 101-103 includes circuitry, programing, or a combination thereof, to support TA acquisition for inter CU mobility in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

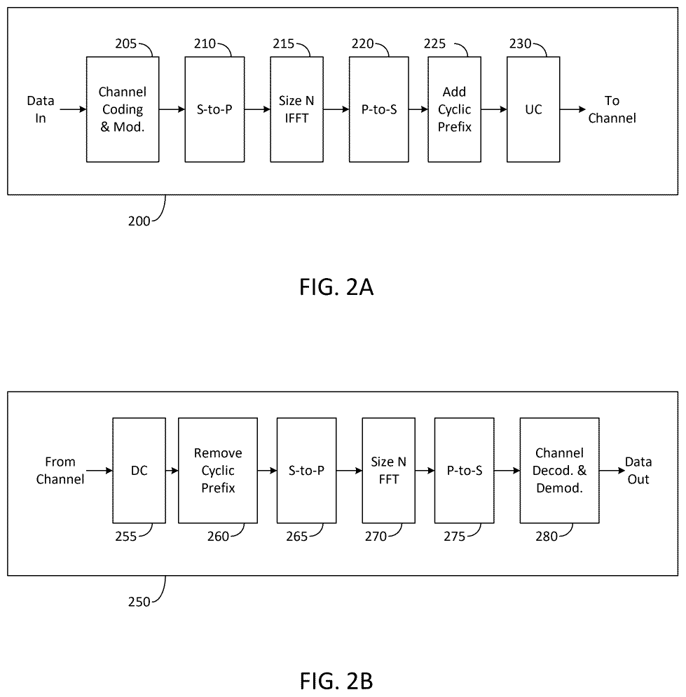

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support TA acquisition for inter CU mobility as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

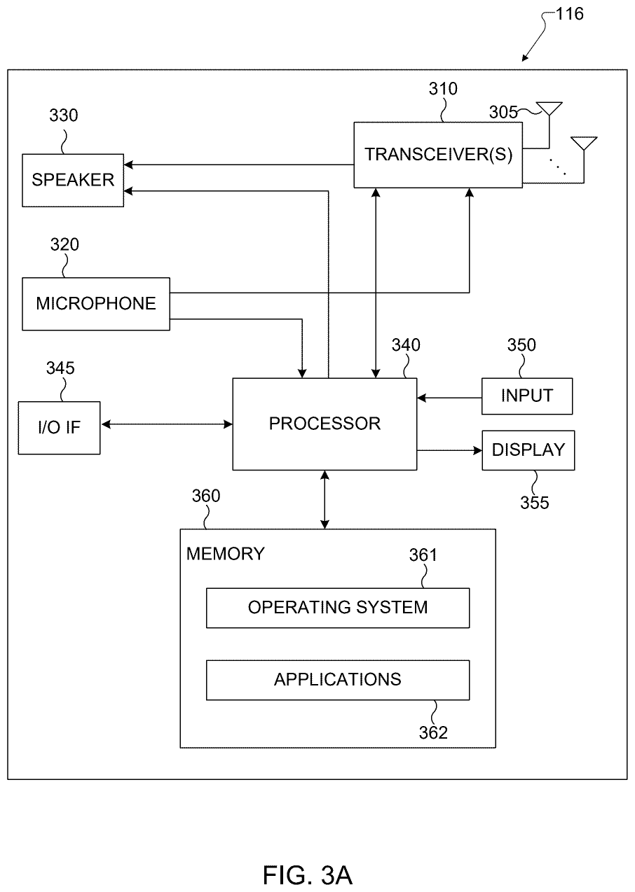

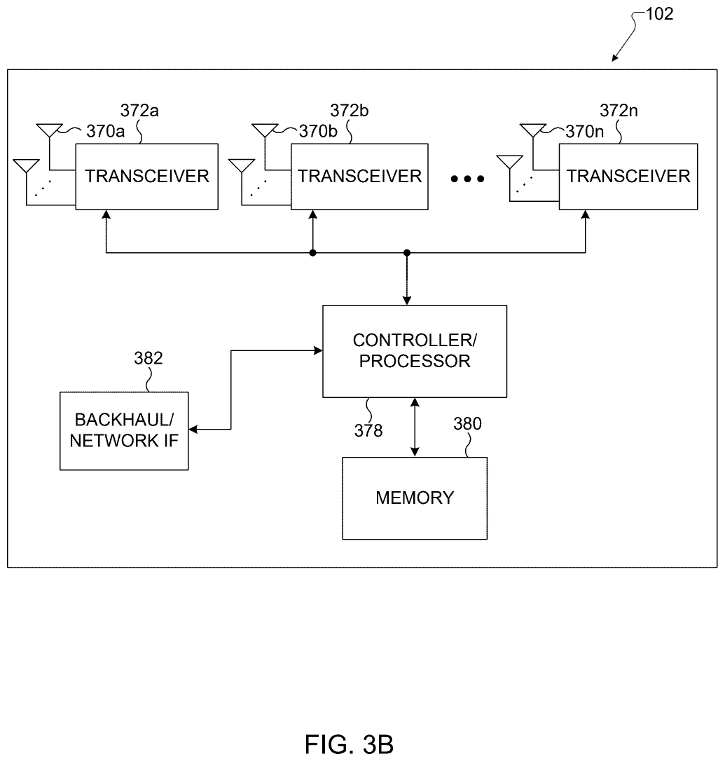

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for TA acquisition for inter CU mobility as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support TA acquisition for inter CU mobility as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G, 6G) operating in higher frequency (mmWave) bands, UEs and gNBs may communicate with each other using Beamforming. Beamforming techniques are used to mitigate propagation path losses and to increase propagation distance for communication at higher frequency bands. Beamforming enhances transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing the propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also be referred to as a transmit (TX) beam. Wireless communication systems operating at high frequency may use a plurality of narrow TX beams to transmit signals in the cell as each narrow TX beam provides coverage to a part of cell. The narrower the TX beam, the higher the antenna gain and hence a larger propagation distance of a signal transmitted using beamforming. A receiver can also generate plurality of receive (RX) beam patterns of different directions. Each of these receive patterns can be also referred to as a receive (RX) beam.

The next generation wireless communication system (e.g., 5G, beyond 5G, 6G) supports a standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) and all secondary cells. In NR the term Master Cell Group (MCG) refers to a group of serving cells associated with the Master Node, comprising the Primary Cell (PCell) and optionally one or more secondary cells (SCells). In NR the term Secondary Cell Group (SCG) refers to a group of serving cells associated with the Secondary Node, comprising the Primary SCG Cell (PSCell) and optionally one or more SCells. In NR, PCell refers to a serving cell in the MCG, operating on the primary frequency, in which the UE either performs the initial connection establishment procedure or initiates the connection re-establishment procedure. In NR for a UE configured with CA, an SCell is a cell providing additional radio resources on top of a Special Cell. PSCell refers to a serving cell in the SCG in which the UE performs random access when performing the Reconfiguration with Sync procedure. For Dual Connectivity operation, Special Cell (SpCell) refers to the PCell of the MCG or the PSCell of the SCG. Otherwise the term Special Cell refers to the PCell.

In the next generation wireless communication system (e.g., 5G, beyond 5G, 6G), a node B (gNB) or base station in cell broadcast Synchronization Signal and PBCH block (SSB) includes primary and secondary synchronization signals (PSS, SSS) and system information (SI). The SI includes common parameters needed to communicate in the cell. In the fifth generation wireless communication system (also referred as next generation radio or NR), SI is divided into the master information block (MIB) and a number of system information blocks (SIBs), wherein the MIB may be transmitted on the broadcast channel (BCH) with a periodicity of 80 ms and repetitions made within 80 ms and the MIB includes parameters that are needed to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI message, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with a same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in SIB1. A cell specific SIB is applicable only within a cell that provides the SIB while an area specific SIB is applicable within an area referred to as an SI area, which includes one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using the RRCReconfiguration message, e.g., if the UE has an active BWP with no common search space configured to monitor system information, paging, or upon request from the UE. In an RRC_CONNECTED state, the UE acquires the required SIB(s) from the PCell. For the PSCell and SCells, the network provides the required SI by dedicated signaling, i.e., within an RRCReconfiguration message. Nevertheless, the UE shall acquire a MIB of the PSCell to get system frame number (SFN) timing of the SCG (which may be different from the MCG). Upon change of relevant SI for the SCell, the network releases and adds the concerned SCell. For the PSCell, the required SI can be changed with Reconfiguration with Sync.

In the next generation wireless communication system (e.g., 5G, beyond 5G, 6G), a Physical Downlink Control Channel (PDCCH) is used to schedule DL transmissions on a Physical Downlink Shared Channel (PDSCH) and UL transmissions on a Physical Uplink Shared Channel (PUSCH), where the Downlink Control Information (DCI) on the PDCCH includes: downlink assignments containing at least modulation and coding format, resource allocation, and hybrid-ARQ information related to DL-SCH; uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for the Physical Uplink Control Channel (PUCCH) and PUSCH; transmission of one or more TPC commands for SRS transmissions by one or more UEs; switching a UE's active bandwidth part (BWP); and initiating a random access procedure. A UE monitors a set of PDCCH candidates in the configured monitoring occasions in one or more configured COntrol REsource SETs (CORESETs) according to the corresponding search space configurations. A CORESET includes a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCEs. Different code rates for the control channels are realized by aggregating different numbers of CCEs. Interleaved and non-interleaved CCE-to-REG mappings are supported in a CORESET. Polar coding is used for the PDCCH. Each resource element group carrying the PDCCH carries its own DeModulation Reference Signal (DMRS). Quadrature Phase Shift Keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. The search space identifier is unique amongst the BWPs of a serving cell. An identifier of search space configuration to be used for specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines a PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

(y*(number of slots in a radio frame)+x−Monitoring-offset-PDCCH-slot)mod(Monitorin-periodicity-PDCCH-slot)=0.

The starting symbol of a PDCCH monitoring occasion in each slot having PDCCH monitoring occasion is given by the parameter Monitoring-symbols-PDCCH-within-slot. The length (in symbols) of a PDCCH monitoring occasion is given in the CORESET associated with the search space. A search space configuration includes the identifier of CORESET configuration associated with it. A list of CORESET configurations are signaled by the gNB for each configured BWP of the serving cell, wherein each CORESET configuration is uniquely identified by a CORESET identifier. The CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots for each supported SCS is pre-defined in NR. Each CORESET configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in a TCI state list is activated and indicated to the UE by the gNB. The TCI state indicates the DL TX beam (DL TX beam is QCLed with an SSB/CSI RS of the TCI state) used by the gNB for transmission of the PDCCH in the PDCCH monitoring occasions of a search space.

In the next generation wireless communication system (e.g., 5G, beyond 5G, 6G) bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE only has to monitor PDCCH on the one active BWP i.e., it does not have to monitor the PDCCH on the entire DL frequency of the serving cell. In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a time. BWP switching is controlled by the PDCCH indicating a downlink assignment or an uplink grant, by the bwp-InactivityTimer, by RRC signalling, or by the MAC entity itself upon initiation of a random access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both UL and DL. Upon expiry of the BWP inactivity timer, the UE switches the active DL BWP to the default DL BWP or initial DL BWP (if a default DL BWP is not configured).

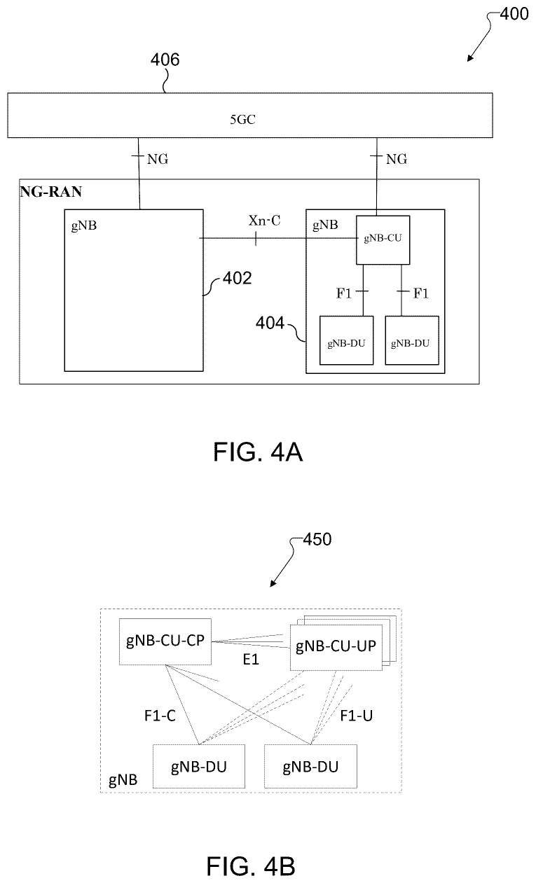

FIG. 4A illustrates an example next generation radio access network (NG-RAN) overall architecture 400 according to embodiments of the present disclosure. The embodiment of an NG-RAN overall architecture of FIG. 4A is for illustration only. Different embodiments of an NG-RAN overall architecture could be used without departing from the scope of this disclosure.

In the example of FIG. 4A, the NG-RAN comprises a set of gNBs 402 and 404 connected to the 5G core (5GC) 406 through NG interfaces. gNBs 402 and 404 can be interconnected through an Xn interface. A gNB may comprise a gNB-central unit (CU) and one or more gNB-distributed unit(s) (DU[s]). A gNB-CU and a gNB-DU are connected via an F1 interface. NG, Xn and F1 interfaces are logical interfaces.

Although FIG. 4A illustrates an example NG-RAN overall architecture 400, various changes may be made to FIG. 4A. For example, architecture 400 could include additional gNBs, different interfaces, etc. according to particular needs.

FIG. 4B illustrates an example architecture 450 for gNB-CU-control plane (CP) and gNB-CU-user plane (UP) separation according to embodiments of the present disclosure. The embodiment of gNB-CU-CP and gNB-CU-UP separation of FIG. 4B is for illustration only. Different embodiments of an architecture for gNB-CU-CP and gNB-CU-UP separation could be used without departing from the scope of this disclosure.

As shown in FIG. 4B, a gNB may comprise a gNB-CU-CP, multiple gNB-CU-UPs and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP. One gNB-CU-UP is connected to only one gNB-CU-CP. One gNB-DU can be connected to multiple gNB-CU-UPs under the control of the same gNB-CU-CP. One gNB-CU-UP can be connected to multiple DUs under the control of the same gNB-CU-CP.

Although FIG. 4B illustrates an example architecture 450 for gNB-CU-CP and gNB-CU-UP separation, various changes may be made to FIG. 450. For example, the gNB could include any number of UPs, DUs, etc. according to particular needs.

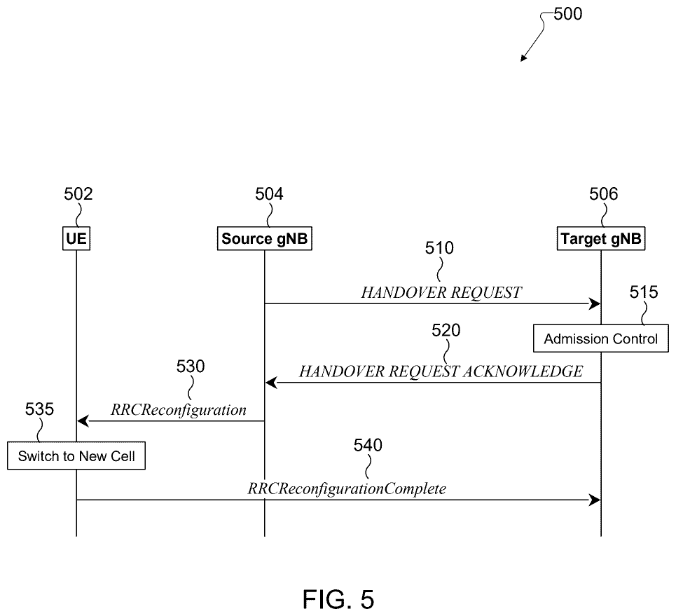

In the next generation wireless communication system (e.g., 5G, beyond 5G, 6G), there are two types of mobility: cell level mobility and beam level mobility. Cell Level Mobility utilizes explicit RRC signaling to be triggering (i.e., handover). For inter-gNB handover, the signaling procedures comprise at least the components shown in FIG. 5.

FIG. 5 illustrates example signaling procedures 500 for inter-gNB handover according to embodiments of the present disclosure. An embodiment of the signaling procedures illustrated in FIG. 5 are for illustration only. One or more of the components illustrated in FIG. 5 may be implemented in specialized circuitry configured to perform the noted functions or one or more of the components may be implemented by one or more processors executing instructions to perform the noted functions. Other embodiments of signaling procedures for inter-gNB handover could be used without departing from the scope of this disclosure.

In the example of FIG. 5, source gNB 504 initiates handover and issues a HANDOVER REQUEST 510 over an Xn interface to a target gNB 506. Target gNB performs admission control at step 515 and provides a new RRC configuration as part of a HANDOVER REQUEST ACKNOWLEDGE 520. Source gNB 504 provides the RRC configuration to UE 502 by forwarding the RRCReconfiguration message 530 received in the HANDOVER REQUEST ACKNOWLEDGE 520. The RRCReconfiguration message 530 includes at least cell ID and all information required to access the target cell so that the UE 502 can access the target cell without reading system information. For some cases, the information required for contention-based and contention-free random access can be included in RRCReconfiguration message 530. The access information to the target cell may include beam specific information, if any. At step 535, UE 502 moves the RRC connection to target gNB 506 and replies with the RRCReconfigurationComplete message 540. The example of FIG. 5 may be referred to as a network controlled or network initiated handover procedure.

Although FIG. 5 illustrates one example of signaling procedures 500 for inter-gNB handover, various changes may be made to FIG. 5. For example, while shown as a series of steps, various steps in FIG. 5 could overlap, occur in parallel, occur in a different order, occur any number of times, be omitted, or replaced by other steps.

Layer 1 (L1)/layer 2 (L2) triggered mobility, also referred to herein as lower layer triggered mobility (LTM), is a procedure in which a gNB receives L1 measurement report(s) from a UE, and on the basis of the L1 measurement report(s) the gNB changes the UE's serving cell by a cell switch command signaled via a MAC CE. The cell switch command indicates an LTM candidate cell configuration that the gNB previously prepared and provided to the UE through RRC signaling. Then the UE switches to the target cell according to the cell switch command. The LTM procedure can be used to reduce mobility latency.

For LTM, the network may indicate one or more L1 measurement based events based on which a UE may initiate LTM execution to a candidate LTM cell without receiving a cell switch command from the gNB. This procedure may be referred to as conditional LTM or UE initiated LTM.

The Network may request the UE to perform early TA acquisition of a candidate cell before a cell switch. The advantage in this situation is that the UE need not perform a random access procedure when the cell switch to the candidate cell is performed. A random access channel (RACH) less cell switch reduces data interruption. The early TA acquisition is triggered by a PDCCH order. An operation for early TA acquisition is described below:
Cell 1 is a source serving cell and belongs to (or is served by) DU 1 and CU 1. Cell 2 is a candidate cell and belongs to (or is served by) DU 2 and CU 1.
Cell 1/DU 1 obtains a Contention free random access (CFRA) resource for Cell 2/DU 2 for early TA acquisition.
   CU1 obtains a CFRA resource for Cell 2/DU 2 from DU 2. CU 1 provides the same to Cell 1/DU 1.
Cell 1/DU 1 sends a PDCCH order to the UE for early TA acquisition of Cell 2. Upon receiving the PDCCH order, the UE initiates a random access procedure and transmits a random access preamble to Cell 2.
If the random access preamble is received by Cell 2:
   Cell 2/DU 2 estimates/determines the TA and indicates the TA, the associated CFRA resource information (preamble index, RA-RNTI), the candidate cell ID and the source gNB-DU ID to CU 1;
   CU 1 sends the TA, the associated CFRA resource information (preamble index, RA-RNTI) the candidate cell ID and the source gNB-DU ID to Cell 1/DU 1.
   Cell 1/DU 1 stores the TA and sends the TA to the UE (e.g., in an LTM cell switch command MAC CE or in a RAR or via an RRC message or via any MAC CE or DCI).
If the random access preamble is not received by Cell 2:
   Cell 2/DU 2 indicates to CU 1 that the preamble is not received. CU 1 sends the same to Cell 1/DU 1. Cell 1/DU 1 sends a PDCCH order with a retransmission indication to the UE. Alternately, if a TA value is not received by Cell 1/DU 1 from Cell 2/DU 2 within a pre-defined timer interval after transmitting the PDCCH order to the UE, Cell 1/DU 1 sends a PDCCH order with a retransmission indication to the UE.

The issue/limitation of the above operation is that the candidate cell (i.e., Cell 2) and source serving cell (i.e., Cell 1) needs to be served by the same CU. As a result, early TA acquisition is only supported for mobility between cells of the same gNB (same CU). Depending on the deployment of the network this may significantly limit the opportunities to perform RACH less LTM/handovers. By enabling RACH less LTM/handover operation between cells of different gNBs (i.e., inter-CU), the network will be able to gain the benefits of RACH less LTM/handover for a far greater number of handovers.

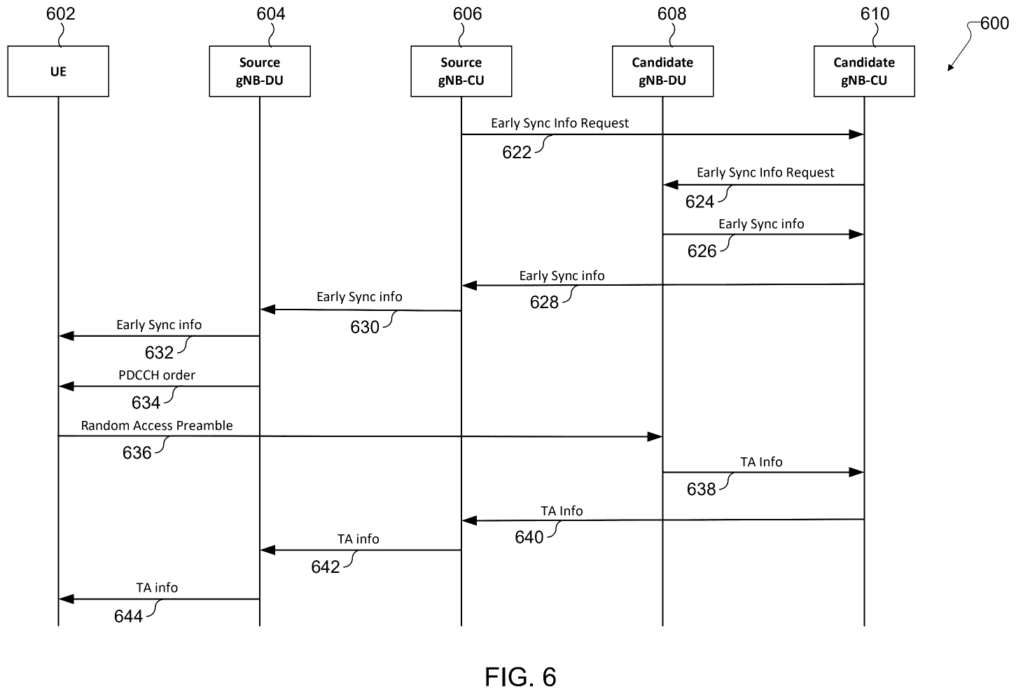

FIG. 6 illustrates an example procedure for early TA acquisition 600 according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for early TA acquisition could be used without departing from the scope of this disclosure.

In the example of FIG. 6, the early TA acquisition procedure is for a candidate cell belonging to a CU different from the CU of a serving cell. Cell 1 is source serving cell and belongs to (or is served by) source gNB-DU 604 and source gNB-CU 606. Cell 2 is a candidate cell and belongs to (or is served by) candidate gNB-DU 608 and candidate gNB-CU 610.

Procedure 600 begins when UE 602 sends a MeasurementReport message (including L3 and/or L1 measurement results) to source gNB-DU 604 containing measurements of neighbouring cells (including candidate cell 2). Source gNB-DU 604 sends an UL RRC MESSAGE TRANSFER message conveying the received MeasurementReport message to source gNB-CU 606. Source gNB-CU 606 determines to initiate an LTM configuration or configuration for mobility towards a candidate cell (Cell 2) belonging to candidate gNB-CU 610.

At step 622, source gNB-CU 606 sends a request for configuration to candidate gNB-CU 610 for a candidate cell (Cell 2). In some embodiments, source gNB-CU 606 may request early sync information (UL synchronization information or early TA acquisition information) from candidate gNB-CU 610. This request may be sent over an Xn interface between source gNB-CU 606 and candidate gNB-CU 610. The request may include a target candidate cell ID (i.e., an ID of Cell 2) and a source gNB-DU ID (the ID of source gNB-DU 604). The request may include a source gNB-CU ID (the ID of Source gNB-CU 606). In some embodiments, this request can be sent in a handover request message.

At step 624, upon receiving the request from source gNB-CU 606, candidate gNB-CU 610 may request early sync information (UL synchronization information or early TA acquisition information) for the candidate cell (Cell 2) from candidate gNB-DU (DU2) 608. This request may be sent over an F1 interface between candidate gNB-CU 610 and candidate gNB-DU 608. The request may include a target candidate cell ID (i.e., the ID of Cell 2) and source gNB-DU ID (the ID of source gNB-DU 604). The request may include a source gNB-CU ID (the ID of Source gNB-CU 606). The target candidate cell ID (i.e., ID of Cell 2), source gNB-CU ID, and source gNB-DU ID (the ID of source gNB-DU 604) are received by candidate gNB-CU 610 from source gNB-CU 606 (e.g., at step 622).

At step 626, upon receiving the request from candidate gNB-CU 610, candidate gNB-DU 608 sends early sync information (UL synchronization information or early TA acquisition information) for a candidate cell (Cell 2) to candidate gNB-CU 610.

In some embodiments, the information may include a RACH Configuration for early TA acquisition (early UL synchronization). This RACH configuration is for the cell identified by target candidate cell ID. Candidate gNB-DU 608 stores the source gNB-DU ID and source gNB-CU ID received from candidate gNB-CU 610 for this RACH configuration. The RACH Configuration may be separately included for a normal uplink carrier (NUL) and supplementary uplink carrier (SUL) if a SUL is supported by Cell 2 (i.e., the cell identified by the target candidate cell ID). In some embodiments, the RACH Configuration for early TA acquisition (early UL synchronization) includes one or more of ssb-PerRACH-Occasion (number of SSBs for RACH occasion), RACH parameters (e.g., PRACH configuration index which indicates PRACH occasions) for performing a random access procedure on a candidate cell, N_TA-Offset to be applied for all uplink transmissions on a candidate cell, subcarrier spacing of PRACH, parameters of an uplink carrier for PRACH transmission on a candidate cell, bwp-GenericParameters, etc. The RACH Configuration may also include one or more preambles for one or more SSBs. The RACH Configuration may also include the number of preambles per SSB.

In some embodiments, candidate gNB-DU 608 may send contention free random access resources (i.e., a list of one or more contention free random access resources, where each contention free random access resource includes a preamble and SSB). These may be separately indicated for SUL and NUL.

At step 628, candidate gNB-CU 610 sends the early sync information (UL synchronization information or early TA acquisition information) received from candidate gNB-DU 608 to source gNB-CU 606. This request may be sent over an Xn interface between source gNB-CU 606 and candidate gNB-CU 610.

At step 630, source gNB-CU 606 sends the early TA acquisition (early UL synchronization) received from candidate gNB-CU 610 to source gNB-DU 604. In some embodiments, source gNB-CU 606 may generate an RRCReconfiguration message including a RACH Configuration for early TA acquisition and send it to source gNB-DU 604. Source gNB-DU 604 may store this information. In some embodiments, source gNB-CU 606 may send contention free random access resources (i.e., a list of one or more contention free random access resources where each contention free random access resource include preamble and SSB) received from candidate gNB-CU 610 to Source gNB-DU 604.

At step 632, source gNB-DU 604 then sends a RACH Configuration for early TA acquisition (early UL synchronization) received from source gNB-CU 606 to UE 602 via the serving cell.

At step 634, source gNB-DU 604, via serving cell 1, sends a PDCCH order to UE 602 for early TA acquisition of candidate cell 2. The PDCCH order indicates an RA preamble index and/or RO(s) to use and a candidate cell ID. The RO(s) are selected from ROs in the RACH configuration received in step 632. If contention free random access preambles are received in step 632, the RA preamble index is selected from these preambles. Otherwise, any preambles can be selected.

At step 636, upon receiving the PDCCH order, UE 602 initiates a random access procedure and transmits the random access preamble to candidate cell 2.

If the random access preamble is received by candidate cell 2: At step 638, candidate cell 2/candidate gNB-DU 608 estimates/determines the TA and indicates the TA, preamble index, RA-RNTI, the candidate cell ID, source gNB-CU ID and the source gNB-DU ID to candidate gNB-CU 610. The preamble index is the index of the random access preamble received by candidate cell 2. The RA-RNTI corresponds to the RACH occasion in which the random access preamble was received by candidate cell 2. The source gNB-DU ID and source gNB-CU ID are the ones which were received by candidate gNB-DU 608 from Candidate gNB-CU in step 624. At step 640, candidate gNB-CU 610 sends the received TA, preamble index, RA-RNTI, the candidate cell ID and the source gNB-DU ID to source gNB-CU 606. At step 642, source gNB-CU 606 sends the TA, preamble index, RA-RNTI, and the candidate cell ID to source gNB-DU 604. At step 644, cell 1/source gNB-DU 604 stores the TA and sends the TA to UE 602 (e.g., in an LTM cell switch command MAC CE or in a RAR or via an RRC message or via any MAC CE or DCI). UE 602 stores the TA and uses the TA for UL transmission when it switches (network initiated or UE initiated) to Candidate cell 2. Source gNB-DU 604 can identify UE 602 based on the preamble index, RA-RNTI and the candidate cell ID.

If the random access preamble is not received by candidate cell 2: candidate cell 2/candidate gNB-DU 608 indicates to candidate gNB-CU 610 that the preamble is not received. Candidate gNB-CU 610 indicates the same to source gNB-CU 606. Source gNB-CU 606 sends the same to source gNB-DU 604. Source gNB-DU 604, via serving cell 1 sends a PDCCH order with a retransmission indication to UE 602. Alternately, if the TA value is not received by candidate cell 1/source gNB-DU 604 within a pre-defined timer interval after transmitting the PDCCH order to UE 602, Candidate cell 1/source gNB-DU 604 sends a PDCCH order with a retransmission indication to UE 602.

In case of a network initiated LTM cell switch to candidate cell 2 belonging to different a CU (CU2) from CU (CU1) of serving cell 1:

Source gNB-DU 604 sends the Cell Switch command to UE 602.

Source gNB-DU 604 sends the DU-CU CELL SWITCH NOTIFICATION message to source gNB-CU 606 to indicate the initiation of the Cell Switch command to UE 602, for which the message includes the target cell ID and the TCI state ID. The message may be sent on an F1 interface between source gNB-DU 604 and source gNB-CU 606.

Source gNB-CU 606 forwards the target cell ID and the TCI state ID to candidate/target gNB-CU 610. The message may be sent on an Xn interface between source gNB-CU 606 and candidate/target gNB-CU 610.

Candidate/target gNB-CU 610 forwards the target cell ID and the TCI state ID to target gNB-DU 608 in the CU-DU CELL SWITCH NOTIFICATION message. The message may be sent on an F1 interface between candidate/target gNB-DU 608 and candidate/target gNB-CU 610.

Target gNB-DU 608 detects the UE 602 access (UE 602 may transmit in UL (RACH or UL-SCH) upon receiving the cell switch command). Target gNB-DU 608 may detect this after receiving a CU-DU CELL SWITCH NOTIFICATION message from Candidate/target gNB-CU 610.

The target gNB-DU 608 sends the ACCESS SUCCESS message to target gNB-CU 610 with the target cell ID.

UE 602 sends an RRCReconfigurationComplete message to target gNB-DU 608.

Target gNB-DU 608 forwards the RRCReconfigurationComplete message to the target gNB-CU 610 via an UL RRC MESSAGE TRANSFER message.

Target gNB-CU 610 may send the message to source gNB-CU 606 to release the resources of the prepared cells.

Source gNB-CU 606 may send the UE CONTEXT RELEASE COMMAND message to source gNB-DU 604 to release the resources of prepared cells.

Source gNB-DU 604 responds with a UE CONTEXT RELEASE COMPLETE message to source gNB-CU606. Source gNB-CU 606 sends a confirmation to target gNB-CU 610. The message is sent on an Xn interface between source gNB-CU 606 and candidate/target gNB-CU 610.

Although FIG. 6 illustrates one example procedure for early TA acquisition 600, various changes may be made to FIG. 6. For example, while shown as a series of steps, various steps in FIG. 6 could overlap, occur in parallel, occur in a different order, occur any number of times, be omitted, or replaced by other steps.

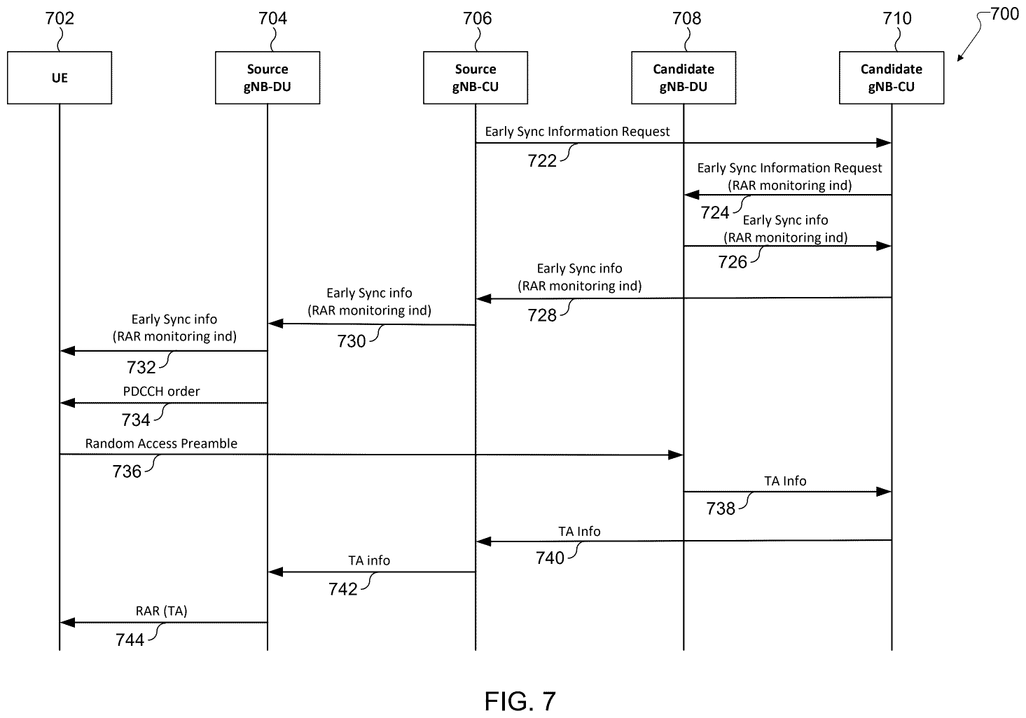

FIG. 7 illustrates another example procedure for early TA acquisition 700 according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for early TA acquisition could be used without departing from the scope of this disclosure.

In the example of FIG. 7, the early TA acquisition procedure is for a candidate cell belonging to a CU different from the CU of a serving cell. Cell 1 is source serving cell and belongs to (or is served by) source gNB-DU 704 and source gNB-CU 706. Cell 2 is a candidate cell and belongs to (or is served by) candidate gNB-DU 708 and candidate gNB-CU 710.

Procedure 700 begins when UE 702 UE sends a MeasurementReport message (including L3 and/or L1 measurement results) to source gNB-DU 704 containing measurements of neighbouring cells (including Cell 2). Source gNB-DU 704 sends an UL RRC MESSAGE TRANSFER message conveying the received MeasurementReport message to source gNB-CU706. Source gNB-CU 706 determines to initiate an LTM configuration or configuration for mobility towards a candidate cell belonging to candidate gNB-CU 710.

At step 722, source gNB-CU 706 sends a request for configuration to candidate gNB-CU 710. In some embodiments, source gNB-CU 706 may request early sync information (UL synchronization information or early TA acquisition information) for a target candidate cell from candidate gNB-CU 710. This request may be sent over an Xn interface between source gNB-CU 706 and candidate gNB-CU 710. The request may include a target candidate cell ID (i.e., the ID of Cell 2) and source gNB-DU ID (the ID of source gNB-DU 704). The request may include a source gNB-CU ID. This request can be sent in a handover request message.

At step 724, upon receiving the request from source gNB-CU 706, candidate gNB-CU 710 may request early sync information (UL synchronization information or early TA acquisition information) for a target candidate cell from candidate gNB-DU 708. for. This request may be sent over an F1 interface between candidate gNB-CU 710 and candidate gNB-DU 708. The request may include the target candidate cell ID, source gNB-CU ID, source gNB-DU ID, etc from source gNB-CU 706 (e.g., from step 722). In some embodiments, the request from candidate gNB-CU 710 may indicate that RAR monitoring is enabled/required for early TA acquisition RA procedure for this target candidate cell. In some embodiments, Candidate gNB-CU 710 may indicate that RAR monitoring is enabled/required for early TA acquisition RA procedure as the request for early sync information is received from source gNB-CU 706.

At step 726, upon receiving the request from candidate gNB-CU 710, candidate gNB-DU 708 sends early sync information (UL synchronization information or early TA acquisition information) for the target candidate cell to candidate gNB-CU 710.

In some embodiments, the information may include a RACH Configuration for early TA acquisition (early UL synchronization). This RACH configuration is for the cell identified by the target candidate cell ID. Candidate gNB-DU 708 stores the source gNB-DU ID and source gNB-CU ID received from candidate gNB-CU 710 for this RACH configuration. The RACH Configuration may be separately included for a normal uplink carrier (NUL) and supplementary uplink carrier (SUL) if a SUL is supported by Cell 2 (i.e., the cell identified by the target candidate cell ID). In some embodiments, the RACH Configuration for early TA acquisition (early UL synchronization) includes one or more of ssb-PerRACH-Occasion (number of SSBs for RACH occasion), RACH parameters (e.g., PRACH configuration index which indicates PRACH occasions) for performing a random access procedure on a candidate cell, N_TA-Offset to be applied for all uplink transmissions on a candidate cell, subcarrier spacing of PRACH, parameters of an uplink carrier for PRACH transmission on a candidate cell, bwp-GenericParameters, etc. the RACH Configuration may also include one or more preambles.

In some embodiments, candidate gNB-DU 708 may send contention free random access resources (i.e., a list of one or more contention free random access resources, where each contention free random access resource includes a preamble and SSB). These may be separately indicated for SUL and NUL.

In some embodiments, the early TA acquisition (early UL synchronization) information may further indicate that RAR monitoring is enabled/required for early TA acquisition RA procedure. Candidate gNB-DU 708 may indicate that RAR monitoring is enabled/required for early TA acquisition RA procedure if the cell identified by the target candidate cell ID belongs to a CU other than candidate gNB-CU 710 or if candidate gNB-CU 710 has indicated that RAR monitoring is enabled/required for early TA acquisition RA procedure in the request. The RACH Configuration may also include one or more preambles for one or more SSBs. The RACH Configuration may also include a number of preambles per SSB.

At step 728, candidate gNB-CU 710 sends the early sync information (UL synchronization information or early TA acquisition information) received from candidate gNB-DU 708 to source gNB-CU 706.

At step 730, source gNB-CU 706 sends the early TA acquisition (early UL synchronization) received from candidate gNB-CU 710 to source gNB-DU 704. In some embodiments, source gNB-CU 706 may generate an RRCReconfiguration message including early TA acquisition information/RACH Configuration for early TA acquisition and send it to source gNB-DU 704. Source gNB-DU 704 may store this information.

In an embodiment, early TA acquisition (early UL synchronization) information sent to source gNB-DU may further indicate that RAR monitoring is enabled/required for early TA acquisition RA procedure. Alternately, Source gNB-CU indicate to source gNB-DU that RAR monitoring is enabled/required for early TA acquisition RA procedure. Source gNB-CU indicates this if early TA acquisition (early UL synchronization) is received from candidate gNB-CU i.e., target candidate cell belongs to a CU different from Source gNB-CU. Source gNB-CU may send contention free random access resources (i.e., list of one or more contention free random access resources where each contention free random access resource include preamble and SSB) received from candidate gNB-CU to Source gNB-DU.

At step 732, source gNB-DU 704 then sends the early TA acquisition information/RACH Configuration for early TA acquisition (early UL synchronization) received from source gNB-CU 706 to UE 702 via the serving cell. This may include an indication that RAR monitoring is enabled/required for early TA acquisition RA procedure.

At step 734, Source gNB-DU 704, via serving cell 1, sends a PDCCH order to UE 702 for early TA acquisition of candidate cell 2. The PDCCH order indicate the RA preamble index and/or RO(s) to use and the candidate cell ID. The RO(s) are selected from ROs in the RACH configuration received in step 732. If contention free random access preambles are received in step 732, the RA preamble index is selected from these preambles. Otherwise, any preambles can be selected. In some embodiments, an indication to monitor for a RAR may be included in the PDCCH order. In some embodiments, source gNB-DU 704 may indicate to UE 702 to monitor for a RAR if the candidate cell identified by the candidate cell ID belongs to a different CU (different from a CU of source gnB-DU 704). In some embodiments, source gNB-DU 704 may indicate to UE 702 to monitor for a RAR if a RAR monitoring indication is received by source gNB-DU 704 in step 730.

At step 736, upon receiving the PDCCH order, UE 702 initiates a random access procedure and transmits the random access preamble to candidate cell 2. UE 702 monitors for a RAR (in the SpCell) if indicated in the PDCCH order or in the early TA acquisition or the early sync information. In some embodiments, UE 702 monitors for a RAR in candidate cell 2.

In some embodiments, if the random access preamble is received by candidate cell 2: At step 638 candidate cell 2/candidate gNB-DU 708 estimates/determines the TA and indicates the TA, preamble index, RA-RNTI, the candidate cell ID, source gNB-CU ID, and the source gNB-DU ID to candidate gNB-CU 710. The Preamble index is the index of the random access preamble received by candidate cell 2. The RA-RNTI corresponds to the RACH occasion in which the random access preamble was received by candidate cell 2. The source gNB-DU ID is the one which was received by candidate gNB-DU 708 from candidate gNB-CU 710 in step 724. At step 740, candidate gNB-CU 710 sends the received TA, preamble index, RA-RNTI, the candidate cell ID and the source gNB-DU ID to source gNB-CU 706. At step 742, source gNB-CU 706 sends the TA, preamble index, RA-RNTI, and the candidate cell ID to source gNB-DU 704. At step 744, cell 1/source gNB-DU 704 sends the TA to UE 702 in a RAR (if RAR monitoring is indicated in the PDCCH order or in the early TA acquisition or the early sync information). UE 702 stores the TA received in the RAR and uses the TA for UL transmission when it switches to Candidate cell 2.

In these embodiments, if the random access preamble is not received by candidate cell 2: candidate cell 2/candidate gNB-DU 708 indicates to candidate gNB-CU 710 that the preamble is not received. Candidate gNB-CU 710 indicates the same to source gNB-CU 706. Source gNB-CU 706 sends the same to source gNB-DU 704. Source gNB-DU 706, via serving cell 1 sends a PDCCH order with a retransmission indication to UE 702. Alternately, if the TA value is not received by candidate cell 1/source gNB-DU 704 within a pre-defined timer interval after transmitting the PDCCH order to UE 702, Candidate cell 1/source gNB-DU 604 sends a PDCCH order with a retransmission indication to UE 702.

In some embodiments, if the random access preamble is received by candidate cell 2: candidate cell 2/candidate gNB-DU 708 estimates/determines the TA. Candidate cell 2/candidate gNB-DU 708 sends the TA to UE 702 in a RAR (if RAR monitoring is indicated in the PDCCH order or in the early TA acquisition or the early sync information). UE 702 stores the TA received in the RAR and uses the TA for UL transmission when it switches to Candidate cell 2.

In these embodiments, if the random access preamble is not received by candidate cell 2: candidate cell 2/candidate gNB-DU 708 indicates to candidate gNB-CU 710 that the preamble is not received. Candidate gNB-CU 710 indicates the same to source gNB-CU 706. Source gNB-CU 706 sends the same to source gNB-DU 704. Source gNB-DU 704, via serving cell 1, sends a PDCCH order with a retransmission indication to UE 702.

Although FIG. 7 illustrates one example procedure for early TA acquisition 700, various changes may be made to FIG. 7. For example, while shown as a series of steps, various steps in FIG. 7 could overlap, occur in parallel, occur in a different order, occur any number of times, be omitted, or replaced by other steps.

The issue/limitation of monitoring for a random access response during early TA acquisition procedure as illustrated in FIG. 7 is that the UE has to receive/transmit from the candidate cell while transmitting/receiving from the serving cell. The UE may not have the capability to TX/RX on a candidate cell and a serving cell concurrently.

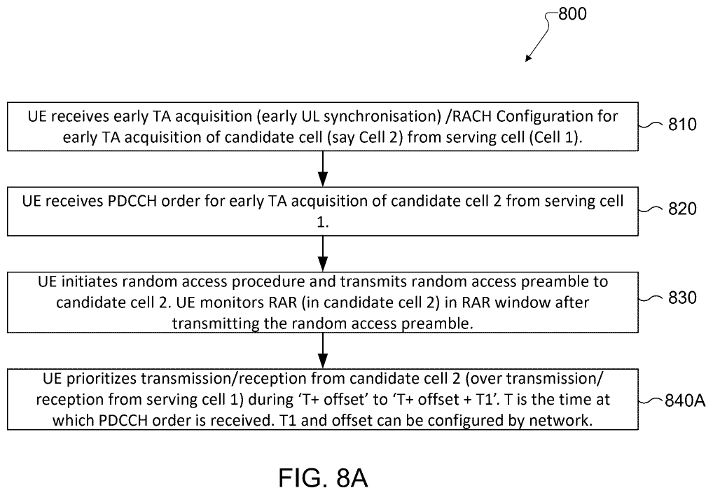

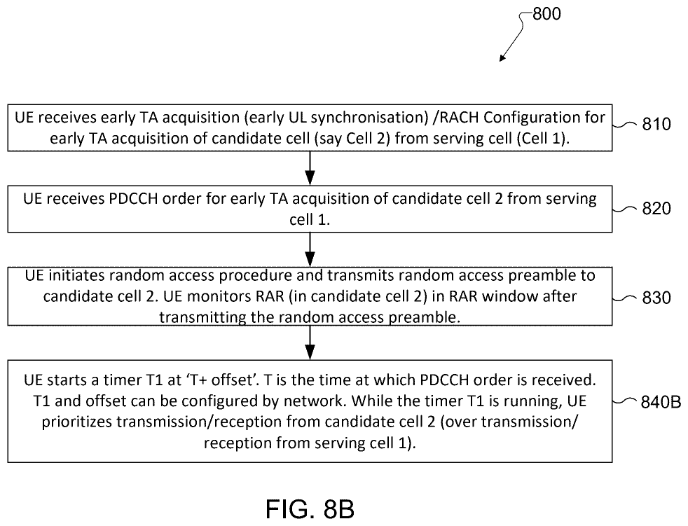

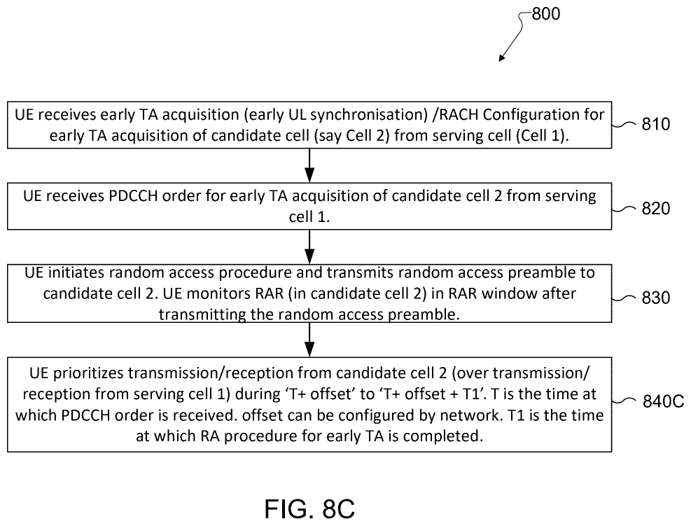

FIGS. 8A-8C illustrate another example procedure for early TA acquisition 800 according to embodiments of the present disclosure wherein the UE does not have the capability to TX/RX on a candidate cell and a serving cell concurrently. An embodiment of the procedure illustrated in FIGS. 8A-8C is for illustration only. One or more of the components illustrated in FIGS. 8A-8C may be implemented in specialized circuitry configured to perform the noted functions or one or more of the components may be implemented by one or more processors executing instructions to perform the noted functions. Other embodiments of a procedure for early TA acquisition could be used without departing from the scope of this disclosure.

In the example of FIGS. 8A-8C, procedure 800 begins at step 810. At step 810, a UE (such as UE 116 of FIG. 1) receives an early TA acquisition (early UL synchronization)/RACH Configuration for early TA acquisition of a candidate cell (e.g., “Cell 2”) from a serving cell (e.g., “Cell 1”). This may be received in an RRCReconfiguration message. The early TA acquisition (early UL synchronization) information/RACH Configuration for early TA acquisition of the candidate cell may further indicate that RAR monitoring is enabled/required for the early TA acquisition RA procedure. The Serving cell may receive contention free random access resources (i.e., a list of one or more contention free random access resources where each contention free random access resource includes a preamble and SSB) received from the candidate cell.

At step 820, Serving cell 1 sends a PDCCH order to the UE for early TA acquisition of candidate cell 2. The PDCCH order indicates an RA preamble index and/or RO(s) to use and a candidate cell ID. The RO(s) are selected from ROs in the RACH configuration received in step 810. If contention free random access preambles are received in step 810, an RA preamble index is selected from these preambles. Otherwise, any preambles can be selected. In some embodiments, an indication to monitor for a RAR may be included in the PDCCH order.

At step 830, upon receiving the PDCCH order, the UE initiates a random access procedure and transmits a random access preamble to candidate cell 2. The UE may select an RO for RA preamble transmission which is not overlapping with any UL transmission to serving cell 1. The UE monitors for a RAR (in candidate cell 2) in a RAR window (which is started after the transmission of the random access preamble in the first PDCCH occasion for monitoring the PDCCH addressed to the RA-RNTI) if indicated in the PDCCH order or in the early TA acquisition or the early sync information. If the RAR window expires and the UE has not received the RAR, the UE may retransmit the random access preamble.

In some embodiments, as shown in FIG. 8A, at step 840A, the UE prioritizes transmission/reception from candidate cell 2 (over transmission/reception from serving cell 1) during a time ‘T+offset’ to ‘T+offset+T1’. For example, if transmission/reception to/from serving cell 1 overlaps with transmission/reception to/from candidate cell 2, the UE performs transmission/reception to candidate cell 2. In these embodiments T is the time at which the PDCCH order is received in step 820. T1 is a time interval that can be configured by the network and received by UE in step 810, or T1 can a be pre-defined time. Offset can be fixed (e.g., offset can be equal to the time needed to process the PDCCH order) or configured by the network and received by the UE in step 810. In some embodiments, offset can be zero or offset is not applied. At the end of ‘T+offset+T1’, the UE terminates the ongoing early TA procedure, if ongoing. Alternately, at the end of ‘T+offset+T1’, the UE continues the early TA procedure in a best effort manner (i.e., the UE prioritizes transmission/reception from serving cell 1 over candidate cell 2). In some embodiments, the UE performs transmission/reception to/from candidate cell 2 during the time ‘T+offset’ to ‘T+offset+T1’ and does not perform transmission/reception to/from serving cell 1 during the time ‘T+offset’ to ‘T+offset+T1’.

In some embodiments, as shown in FIG. 8B, at step 840B the UE starts a timer T1 at a time ‘T+offset’. In these embodiments T is the time at which the PDCCH order is received in step 810. T1 is a time interval that can be configured by the network and received by the UE in step 810, or T1 can be a pre-defined time. Offset can be fixed (e.g., offset can be equal to the time needed to process the PDCCH order) or configured by the network and received by the UE in step 810. While the timer T1 is running, the UE prioritizes transmission/reception from candidate cell 2 (over transmission/reception from serving cell 1). For example, if transmission/reception to/from serving cell 1 overlaps with transmission/reception to/from candidate cell 2, the UE performs transmission/reception to candidate cell 2. When T1 expires, the UE terminates the ongoing early TA procedure, if ongoing. Alternately, when T1 expires, the UE continues early TA procedure in a best effort manner (i.e., the UE prioritizes transmission/reception from serving cell 1 over candidate cell 2). Timer T1 (if running) is stopped when the random access procedure is completed (e.g., a RAR is successfully received). In some embodiments, the UE performs transmission/reception to/from candidate cell 2 while timer T1 is running and does not perform transmission/reception to/from serving cell 1 while timer T1 is running.

In some embodiments, the UE prioritizes transmission/reception from candidate cell 2 (over transmission/reception from serving cell 1) during a time ‘T’ to ‘T+T1’. For example, if transmission/reception to/from serving cell 1 overlaps with transmission/reception to/from candidate cell 2, the UE performs transmission/reception to candidate cell 2. In these embodiments T is the time at which the PDCCH order is received in step 820. T1 is a time that can be configured by the network and received by the UE in step 810, or T1 can be a pre-defined time. At the end of ‘T+T1’, the UE terminates the ongoing early TA procedure, if ongoing. Alternately, at the end of ‘T+T1’, the UE continues the early TA procedure in a best effort manner (i.e., the UE prioritizes transmission/reception from serving cell 1 over candidate cell 2.) In some embodiments, the UE performs transmission/reception to/from candidate cell 2 during the time ‘T+offset’ to ‘T+T1’ and does not perform transmission/reception to/from serving cell 1 during the time ‘T+offset’ to ‘T+T1’.

In some embodiments, the UE starts a timer T1 at a time ‘T’. In these embodiments, T is the time at which the PDCCH order is received in step 820. T1 is a time that can be configured by the network and received by the UE in step 810, or T1 can be a pre-defined time. While the timer T1 is running, the UE prioritizes transmission/reception from candidate cell 2 (over transmission/reception from serving cell 1). For example, if transmission/reception to/from serving cell 1 overlaps with transmission/reception to/from candidate cell 2, the UE performs transmission/reception to candidate cell 2. When T1 expires, the UE terminates the ongoing early TA procedure, if ongoing. Alternately, when T1 expires, the UE continues the early TA procedure in a best effort manner (i.e., it prioritizes transmission/reception from serving cell 1 over candidate cell 2). Timer T1 (if running) is stopped when the random access procedure is completed (e.g., a RAR is successfully received). In some embodiments, the UE performs transmission/reception to/from candidate cell 2 while timer T1 is running and does not perform transmission/reception to/from serving cell 1 while timer T1 is running.

In some embodiments, as shown in FIG. 8C, at step 840C, the UE prioritizes transmission/reception from candidate cell 2 (over transmission/reception from serving cell 1) during a time ‘T+offset’ to ‘T+offset+T1’. For example, if transmission/reception to/from serving cell 1 overlaps with transmission/reception to/from candidate cell 2, the UE performs transmission/reception to candidate cell 2. In these embodiments, T is the time at which the PDCCH order is received in step 820. T1 is the time at which the RA procedure for early TA is completed (e.g., the RAR is successfully received or contention resolution is successful). The UE informs serving cell 1 when the RA procedure for early TA is completed. Offset is a time that can be fixed (e.g., it is equal to the time needed to process the PDCCH order) or configured by the network and received by the UE in step 810. In some embodiments, offset can be zero or offset is not applied. In some embodiments, the UE performs transmission/reception to/from candidate cell 2 during the time ‘T+offset’ to ‘T+T1’ and does not perform transmission/reception to/from serving cell 1 during the time ‘T+offset’ to ‘T+T1’.

In some embodiments, the UE prioritizes transmission/reception from the candidate cell 2 (over transmission/reception from serving cell 1) during a time ‘T to ‘T+T1’. For example, if transmission/reception to/from serving cell 1 overlaps with transmission/reception to/from candidate cell 2, the UE performs transmission/reception to candidate cell 2. In these embodiments, T is the time at which the PDCCH order is received in step 820. T1 is the time at which the RA procedure for early TA is completed (e.g., a RAR is successfully received or contention resolution is successful). The UE informs serving cell 1 when the RA procedure for early TA is completed. In some embodiments, the UE performs transmission/reception to/from candidate cell 2 during the time ‘T’ to ‘T+T1’ and does not perform transmission/reception to/from serving cell 1 during the time ‘T’ to ‘T+T1’.

In some embodiments, the UE prioritizes RA preamble transmission and RAR reception from candidate cell 2 over transmission (TX)/reception (RX) from serving cell 1. Alternately, the network may indicate whether the UE prioritizes RA preamble transmission and RAR reception from candidate cell 2 over TX/RX from serving cell 1. If indicated to prioritize, the UE deprioritizes RA preamble transmission and RAR reception from candidate cell 2 over TX/RX from serving cell 1.

In some embodiments, the UE prioritizes RA preamble transmission and RAR reception from candidate cell 2 over transmission/reception from serving cell 1 except for transmission/reception for certain logical channel(s) (LCH[s])/emergency calls to/from serving cell 1. The certain LCH(s) may be signaled by the network e.g., in step 810.

In some embodiments, the UE deprioritizes RA preamble transmission and RAR reception from candidate cell 2 over TX/RX from serving cell 1. Alternately, the network may indicate whether the UE deprioritizes RA preamble transmission and RAR reception from candidate cell 2 over TX/RX from serving cell 1. If indicated to deprioritize, the UE deprioritizes RA preamble transmission and RAR reception from candidate cell 2 over TX/RX from serving cell 1.

In some embodiments, the network may indicate specific RO(s) (a specific location in time is indicated) for transmitting a RA preamble. Based on the location of the RO, the location of the RAR window is known. Serving cell 1 will not transmit to the UE during the RAR window and not schedule UL transmission during indicated RO(s).

If the random access preamble is received by candidate cell 2: Candidate cell 2 estimates/determines the TA. Candidate cell 2 sends the TA to the UE in a RAR (if RAR monitoring is indicated in the PDCCH order or in the early TA acquisition or the early sync information). For the RAR, Candidate cell 2 sends a PDCCH addressed to the RA-RNTI in the RAR window. The UE stores the TA received in the RAR and uses the TA for UL transmission when it switches to Candidate cell 2. Upon reception of the RAR or completion of the random access procedure for early TA acquisition, the UE may inform serving cell 1 that the random access procedure for early TA acquisition is completed.

In some embodiments, the operation for early TA acquisition procedure when the serving cell and candidate cell belong to different CUs may be as described below:
Cell 1/DU1 obtains a CFRA resource for Cell 2/DU 2 for early TA.
   CU1 obtains the CFRA resource for Cell 2/DU 2 from CU 2.
      CU2 obtains the CFRA resource for Cell 2/DU 2 from DU 2. CU 2 provides the same to CU 1
   CU1 provides the same to Cell 1/DU 1.
Cell 1/DU1 sends a PDCCH order to the UE for early TA acquisition of Cell 2.
The UE transmits a preamble to Cell 2. The UE starts a RAR window. The Network indicates to the UE to monitor for a RAR of the candidate cell for inter CU LTM candidate cell.

Depending on UE capability, the UE may not receive cell 1 and cell 2 simultaneously. If the UE is not capable of simultaneous reception/transmission, it may prioritize transmission/reception of the candidate cell/serving cell as explained earlier.

If a preamble is received by Cell 2: Cell 2/DU 2 sends a RAR with the TA to the UE. The UE stores the TA received in the RAR and uses the TA for UL transmission when the UE switches to Candidate cell 2.

Cell 1 may need to know when/whether the early TA procedure is completed. The UE can indicate or CU 2 can indicate the completion to CU 1.

Although FIGS. 8A-8C illustrate one example procedure for early TA acquisition 800, various changes may be made to FIGS. 8A-8C. For example, while shown as a series of steps, various steps in FIGS. 8A-8C could overlap, occur in parallel, occur in a different order, occur any number of times, be omitted, or replaced by other steps.

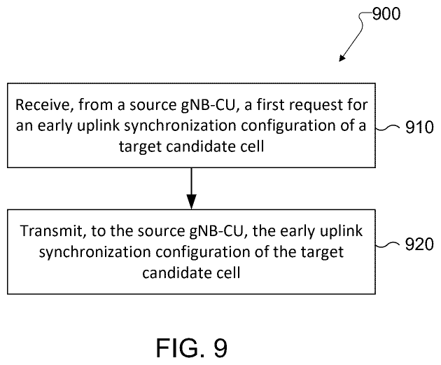

FIG. 9 illustrates an example method for TA acquisition for inter CU mobility 900 according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a method for TA acquisition for inter CU mobility could be used without departing from the scope of this disclosure.

In the example of FIG. 9, method 900 begins at step 910. At step 910, a gNB-CU (such as candidate gNB-CU 610 of FIG. 6) receives, from a source gNB-CU (such as source gNB-CU 606 of FIG. 6), a first request for an early uplink synchronization configuration of a target candidate cell.

In some embodiments, the first request includes at least one of a target candidate cell ID, a source gNB-DU ID, and a source gNB-CU ID.

At step 920, the gNB-CU transmits, to the source gNB-CU, the early uplink synchronization configuration of the target candidate cell.

In some embodiments, method 900 further includes: (1) upon receiving the first request, transmitting, to a gNB-distributed unit (DU) of the target candidate cell, a second request for an early uplink synchronization configuration of the target candidate cell; and (2) receiving, from the gNB-DU of the target candidate cell, the early uplink synchronization configuration of the target candidate cell. In some embodiments, the second request includes at least one of a target candidate cell ID received in the first request, a source gNB-DU ID received in the first request, and a source gNB-CU ID received in the first request.

In some embodiments, the gNB-CU may further: (1) receive, from a gNB-DU of the target candidate cell, at least one of TA information, a target candidate cell ID, a source gNB-CU ID, and a source gNB-DU ID; and (2) transmit, to the source gNB-CU, at least one of the TA information, the target candidate cell ID, and the source gNB-DU ID. In some embodiments, the TA information may include at least one of a TA value, a preamble index, and a RA-RNTI. In some embodiments, the TA information may be determined based on a random access preamble received by the target candidate cell.

Although FIG. 9 illustrates one example method for TA acquisition for inter CU mobility 900, various changes may be made to FIG. 9. For example, while shown as a series of steps, various steps in FIG. 9 could overlap, occur in parallel, occur in a different order, occur any number of times, be omitted, or replaced by other steps.

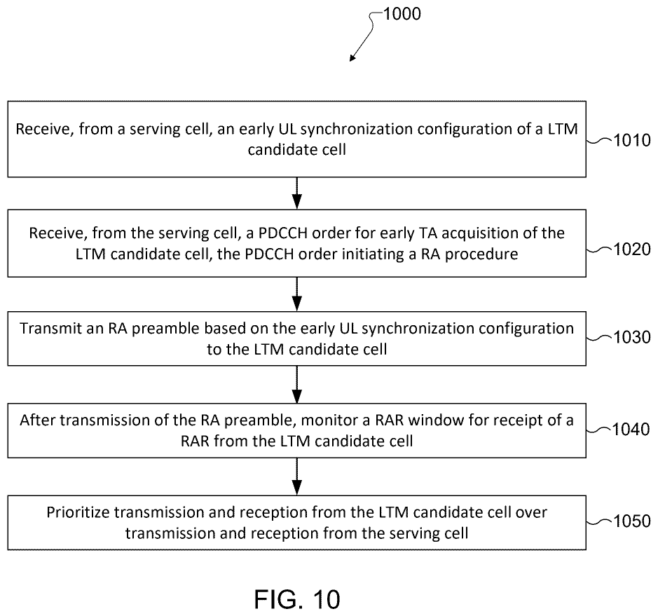

FIG. 10 illustrates another example method for TA acquisition for inter CU mobility 1000 according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for TA acquisition for inter CU mobility could be used without departing from the scope of this disclosure.

In the example of FIG. 10 method 1000 begins at step 1010. At step 1010, a UE (such as UE 116 of FIG. 1) receives, from a serving cell, an early UL synchronization configuration of a LTM candidate cell.

At step 1020, the UE receives, from the serving cell, a PDCCH order for early TA acquisition of the LTM candidate cell, the PDCCH order initiating a RA procedure.

At step 1030, the UE transmits an RA preamble based on the early UL synchronization configuration to the LTM candidate cell.

At step 1040, after transmission of the RA preamble, the UE monitors a RAR window for receipt of a RAR from the LTM candidate cell.

At step 1050, the UE prioritizes transmission and reception from the LTM candidate cell over transmission and reception from the serving cell.

In some embodiments, the PDCCH order may be received at a time ‘T.’

In some embodiments, the UE may further: (1) receive a time ‘T1’ and an offset ‘O’ from the serving cell, and (2) prioritize the transmission and reception from the LTM candidate cell over the transmission and reception from the serving cell during a time ‘T+O’ to a time ‘T+O+T1’.

In some embodiments, the UE may further: (1) receive a timer'T1'and an offset ‘O’ from the serving cell, (2) start the timer T1 at a time ‘T+O’, and (3) prioritize the transmission and reception from the LTM candidate cell over the transmission and reception from the serving cell while the timer T1 is running.

In some embodiments, the RA procedure initiated by the PDCCH order is completed at a time ‘T1’. In some embodiments, the UE may further: (1) receive an offset ‘O’ from the serving cell, and (2) prioritize the transmission and reception from the LTM candidate cell over the transmission and reception from the serving cell during a time ‘T+O’ to a time ‘T+O+T1’.

In some embodiments, the UE may prioritize the transmission of the RA preamble to the LTM candidate cell and RAR reception from the LTM candidate cell over transmission and reception from the serving cell.

In some embodiments, the UE may except for certain LCHs and emergency calls to and from the serving cell, prioritize the transmission of the RA preamble to the LTM candidate cell and RAR reception from the LTM candidate cell over transmission and reception from the serving cell.

In some embodiments, the UE may deprioritize the transmission of the RA preamble to the LTM candidate cell and RAR reception from the LTM candidate cell over transmission and reception from the serving cell.

Although FIG. 10 illustrates one example method for TA acquisition for inter CU mobility 1000, various changes may be made to FIG. 10. For example, while shown as a series of steps, various steps in FIG. 10 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A gNodeB (gNB)-central unit (CU) comprising:
a processor; and
a transceiver operatively coupled to the processor, the transceiver configured to:
receive, from a source gNB-CU, a first request for an early uplink synchronization configuration of a target candidate cell; and
transmit, to the source gNB-CU, the early uplink synchronization configuration of the target candidate cell.

2. The gNB-CU of claim 1, wherein the first request includes at least one of:
a target candidate cell identification (ID);
a source gNB-distributed unit (DU) ID; and
a source gNB-CU ID.

3. The gNB-CU of claim 1, wherein the transceiver is further configured to:
upon receiving the first request, transmit, to a gNB-distributed unit (DU) of the target candidate cell, a second request for an early uplink synchronization configuration of the target candidate cell; and
receive, from the gNB-DU of the target candidate cell, the early uplink synchronization configuration of the target candidate cell.

4. The gNB-CU of claim 3, wherein the second request includes at least one of:
a target candidate cell identification (ID) received in the first request;
a source gNB-distributed unit (DU) ID received in the first request; and
a source gNB-CU ID received in the first request.

5. The gNB-CU of claim 1, wherein the transceiver is further configured to:
receive, from a gNB-distributed unit (DU) of the target candidate cell, at least one of:
timing advance (TA) information;
a target candidate cell identification (ID);
a source gNB-CU ID; and
a source gNB-DU ID, and
transmit, to the source gNB-CU, at least one of:
the TA information;
the target candidate cell ID; and
the source gNB-DU ID.

6. The gNB-CU of claim 5, wherein the TA information includes at least one of:
a TA value;
a preamble index; and
a random access (RA)-radio network temporary identifier (RNTI).

7. The gNB-CU of claim 5, wherein the TA information is determined based on a random access preamble received by the target candidate cell.

8. A user equipment (UE) comprising:
a transceiver configured to:
receive, from a serving cell, an early uplink (UL) synchronization configuration of a lower layer triggered mobility (LTM) candidate cell;
receive, from the serving cell, a physical downlink control channel (PDCCH) order for early timing advance (TA) acquisition of the LTM candidate cell, the PDCCH order initiating a random access (RA) procedure; and
transmit an RA preamble based on the early UL synchronization configuration to the LTM candidate cell; and
a processor operatively coupled to the transceiver, the processor configured to:
after transmission of the RA preamble, monitor a RA response (RAR) window for receipt of a RAR from the LTM candidate cell; and
prioritize transmission and reception from the LTM candidate cell over transmission and reception from the serving cell.

9. The UE of claim 8, wherein:
the PDCCH order is received at a time ‘T’;
the transceiver is further configured to receive a time ‘T1’ and an offset ‘O’ from the serving cell; and
the processor is further configured to prioritize the transmission and reception from the LTM candidate cell over the transmission and reception from the serving cell during a time ‘T+O’ to a time ‘T+O+T1’.

10. The UE of claim 8, wherein:
the PDCCH order is received at a time ‘T’;
the transceiver is further configured to receive a timer'T1'and an offset ‘O’ from the serving cell;
the processor is further configured to start the timer T1 at a time ‘T+O’; and
the processor is further configured to prioritize the transmission and reception from the LTM candidate cell over the transmission and reception from the serving cell while the timer T1 is running.

11. The UE of claim 8, wherein:
the PDCCH order is received at a time ‘T’;
the RA procedure initiated by the PDCCH order is completed at a time ‘T1’;
the transceiver is further configured to receive an offset ‘O’ from the serving cell; and
the processor is further configured to prioritize the transmission and reception from the LTM candidate cell over the transmission and reception from the serving cell during a time ‘T+O’ to a time ‘T+O+T1’.

12. The UE of claim 8, wherein the processor is further configured to prioritize the transmission of the RA preamble to the LTM candidate cell and RAR reception from the LTM candidate cell over transmission and reception from the serving cell.

13. The UE of claim 8, wherein the processor is further configured to, except for certain logical channels (LCHs) and emergency calls to and from the serving cell, prioritize the transmission of the RA preamble to the LTM candidate cell and RAR reception from the LTM candidate cell over transmission and reception from the serving cell.

14. The UE of claim 8, wherein the processor is further configured to deprioritize the transmission of the RA preamble to the LTM candidate cell and RAR reception from the LTM candidate cell over transmission and reception from the serving cell.

15. A method of operating a gNodeB (gNB)-central unit (CU), the method comprising:
receiving, from a source gNB-CU, a first request for an early uplink synchronization configuration of a target candidate cell; and
transmitting, to the source gNB-CU, the early uplink synchronization configuration of the target candidate cell.

16. The method of claim 15, wherein the first request includes at least one of:
a target candidate cell identification (ID);
a source gNB-distributed unit (DU) ID; and
a source gNB-CU ID.

17. The method of claim 15, further comprising:
upon receiving the first request, transmitting, to a gNB-distributed unit (DU) of the target candidate cell, a second request for an early uplink synchronization configuration of the target candidate cell; and
receiving, from the gNB-DU of the target candidate cell, the early uplink synchronization configuration of the target candidate cell,
wherein the second request includes at least one of:
a target candidate cell identification (ID) received in the first request;
a source gNB-distributed unit (DU) ID received in the first request; and
a source gNB-CU ID received in the first request.

18. The method of claim 15, further comprising:
receiving, from a gNB-distributed unit (DU) of the target candidate cell, at least one of:
timing advance (TA) information;
a target candidate cell identification (ID);
a source gNB-CU ID; and
a source gNB-DU ID, and
transmitting, to the source gNB-CU, at least one of:
the TA information;
the target candidate cell ID; and
the source gNB-DU ID.

19. The method of claim 18, wherein the TA information includes at least one of:
a TA value;
a preamble index; and
a random access (RA)-radio network temporary identifier (RNTI).

20. The method of claim 18, wherein the TA information is determined based on a random access preamble received by the target candidate cell.
